(19) United States
(12) Patent Application Publication
(10) Pub. No.: US 2014/0060798 A1
(43) Pub. Date: Mar. 6, 2014

(54) Configuring A Liquid Cooling System Associated With Electrical Computing Racks

(71) Applicants: Eric A. Eckberg, Rochester, MN (US); Howard V. Mahaney, JR., Cedar Park, TX (US); Michael S. Miller, Raleigh, NC (US); Tejas Shah, Austin, TX (US)

(72) Inventors: Eric A. Eckberg, Rochester, MN (US); Howard V. Mahaney, JR., Cedar Park, TX (US); Michael S. Miller, Raleigh, NC (US); Tejas Shah, Austin, TX (US)

(73) Assignee: INTERNATIONAL BUSINESS MACHINES CORPORATION, ARMONK, NY (US)

(21) Appl. No.: 13/600,695

(22) Filed: Aug. 31, 2012

(51) Int. Cl. F28D 15/00; G05D 23/00

(52) U.S. Cl. 165/287; 165/104.33

(57) ABSTRACT

Apparatuses and computer program products for configuring a liquid cooling system are provided. Embodiments include a valve controller determining a temperature of liquid within a particular portion of the liquid cooling system; determining whether the temperature of the liquid within the particular portion of the liquid cooling system exceeds a predetermined threshold; if predetermined threshold is not exceeded, configuring, one or more valves such that liquid directly exiting a first liquid cooling apparatus of a first electrical component rack is used in a second liquid cooling apparatus to cool a second electrical component rack; and if the predetermined threshold is exceeded, configuring the one or more valves such that liquid directly exiting a main supply line of the liquid cooling system is used in the second liquid cooling apparatus to cool the second electrical component rack.

### BACKGROUND OF THE INVENTION

1. Field of the Invention

The field of the invention is data processing, or, more specifically, methods, apparatuses, and computer program products for configuring a liquid cooling system associated with electrical computing racks.

2. Description of Related Art

Modern computing systems include computing components that frequently generate high levels of heat during operation. Because high levels of heat can damage computing components and degrade the performance of computing systems, the need for cooling technologies to cool computing systems has increased. Modern cooling technologies are typically electrically powered. As the burden placed on modern cooling systems has increased, the amount of electricity required to power such modern computing systems has also risen, thereby increasing the costs associated with cooling modern computing systems.

### SUMMARY OF THE INVENTION

A liquid cooling system for cooling a plurality of electrical component racks is provided. Embodiments include a first liquid cooling apparatus configured to cool a first electrical component rack and a second liquid cooling apparatus configured to cool a second electrical component rack. In particular embodiments, the first liquid cooling apparatus and the second liquid cooling apparatus are connected such that liquid directly exiting the first liquid cooling apparatus of the first electrical component rack is used in the second liquid cooling apparatus to cool the second electrical component rack.

Methods, apparatuses, and computer program products for configuring a liquid cooling system comprising of a plurality of liquid cooling apparatuses each of which is configured to cool a particular electrical component rack are also provided. Embodiments include a valve controller determining a temperature of liquid within a particular portion of the liquid cooling system; determining whether the temperature of the liquid within the particular portion of the liquid cooling system exceeds a predetermined threshold; if predetermined threshold is not exceeded, configuring, one or more valves such that liquid directly exiting a first liquid cooling apparatus of a first electrical component rack is used in a second liquid cooling apparatus to cool a second electrical component rack; and if the predetermined threshold is exceeded, configuring the one or more valves such that liquid directly exiting a main supply line of the liquid cooling system is used in the second liquid cooling apparatus to cool the second electrical component rack.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in configuring a liquid cooling system according to embodiments of the present invention.

FIG. 2 sets forth a block diagram of an example liquid cooling system configured according to embodiments of the present invention.

FIG. 3 sets forth a block diagram of another example liquid cooling system configured according to embodiments of the present invention.

FIG. 4 sets forth a block diagram of another example liquid cooling system configured according to embodiments of the present invention.

FIG. 5 sets forth a block diagram of another example liquid cooling system configured according to embodiments of the present invention.

FIG. 6 sets forth a block diagram of another example liquid cooling system configured according to embodiments of the present invention.

FIG. 7 sets forth a flow chart illustrating an exemplary method for configuring a liquid cooling system according to embodiments of the present invention

FIG. 8 sets forth a flow chart illustrating a further exemplary method for configuring a liquid cooling system according to embodiments of the present invention.

FIG. 9 sets forth a flow chart illustrating a further exemplary method for configuring a liquid cooling system according to embodiments of the present invention.

FIG. 10 sets forth a flow chart illustrating a further exemplary method for configuring a liquid cooling system according to embodiments of the present invention.

FIG. 11 sets forth a block diagram of another example liquid cooling system configured according to embodiments of the present invention.

### DETAILED DESCRIPTION OF EXEMPLARY EMBODIMENTS

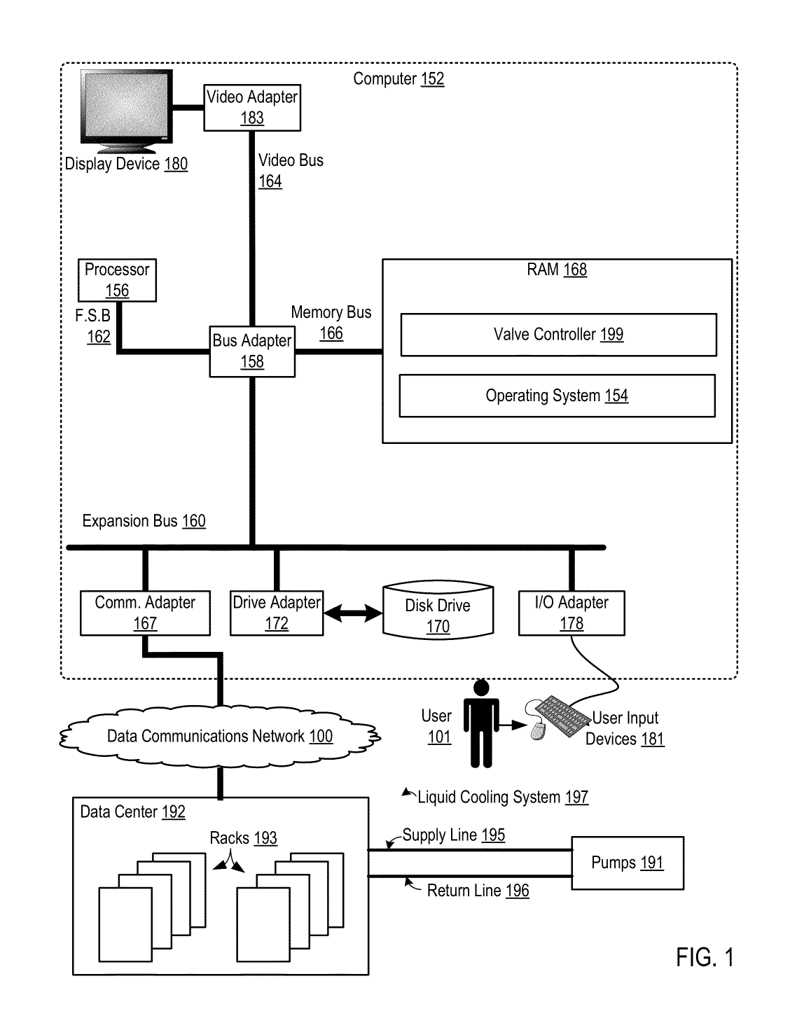

Exemplary methods, apparatuses, and computer program products for configuring a liquid cooling system in accordance with the present invention are described with reference to the accompanying drawings, beginning with FIG. 1. Configuring a liquid cooling system in accordance with the present invention may be generally implemented with computers, that is, with automated computing machinery. FIG. 1 sets forth a block diagram of automated computing machinery comprising an exemplary computer (152) useful in configuring a liquid cooling system (197) according to embodiments of the present invention.

A liquid cooling system is a general term that refers to all of the apparatuses and components used to cool a particular set of electrical components. In the example of FIG. 1, the liquid cooling system (197) is used to cool electrical component racks (193) located within a data center (192).

The liquid cooling system (197) includes pumps (191) for pumping liquid from a source, such as a liquid reservoir, into a supply line (195), through the data center (192) and into a return line (196) for delivery back to the source. As will be explained in greater detail below, the liquid cooling system (197) also includes individual cooling apparatuses that use the liquid from the supply line (195) to cool the electrical component racks. Examples of individual cooling apparatuses include, but are not limited to, air-to-liquid heat exchangers, such as rear door heat exchangers and side-car type heat exchangers (sometimes referred to as in-row coolers), and direct liquid cooling systems. As will also be explained in greater detail below, in certain circumstances, cooling apparatuses may be coupled in a series configuration so that liquid directly exiting one cooling apparatus may be used in another cooling apparatus.

A configuration of a liquid cooling system refers to the particular connections between individual cooling apparatuses and components that make up the liquid cooling system. For example, in a first configuration one or more individual cooling apparatuses may use liquid directly exiting another cooling apparatus and in another configuration those same cooling apparatuses may only use liquid directly exiting a supply line. According to embodiments of the present invention, a methodology is employed to make changes within the cooling system based upon information received. This could be manual adjusting of a valve, temperature actuated valves, or, as depicted in FIG. 1, a computer (152) designed to control the configuration of the liquid cooling system (197).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a valve controller (199) that includes computer program instructions for configuring a liquid cooling system (197) according to embodiments of the present invention. Specifically, a valve controller controls one or more valves. In a particular embodiment of the present invention, a valve controller may be integrated into a particular valve and be configured to control only that valve. In other embodiments, a valve controller may be configured to control a plurality of valves and may be located anywhere outside the valve, such as a control room of a data center. In the example of FIG. 1, the valve controller is represented by computer program instructions that when executed by the computer (152) cause the computer (152) to control the liquid cooling system (197). Although this particular embodiment is illustrated in FIG. 1, readers of skill in the art will realize that a valve controller may have many forms and capabilities according to embodiments of the present invention.

In the example of FIG. 1, the valve controller (199) includes computer program instructions that when executed by the processor (156) cause the computer (152) to carry out the following steps of determining, by the valve controller (199), a temperature of liquid within a particular portion of the liquid cooling system (197) and determining whether the temperature of the liquid within the particular portion of the liquid cooling system (197) exceeds a predetermined threshold. If the predetermined threshold is not exceeded, the valve controller (199) configures one or more valves of the liquid cooling system (197) such that liquid directly exiting a first liquid cooling apparatus of a first electrical component rack is used in a second liquid cooling apparatus to cool a second electrical component rack. If the predetermined threshold is exceeded, the valve controller (199) configures the one or more valves such that liquid directly exiting a supply line (195) of the liquid cooling system (197) is used in the second liquid cooling apparatus to cool the second electrical component rack. That is, according to embodiments of the present invention, a valve controller may, based on a temperature of liquid within the liquid cooling system, change a configuration of a liquid cooling system such that a cooling apparatus uses liquid directly exiting another cooling apparatus. Using within a cooling apparatus, liquid directly exiting another cooling apparatus, instead of liquid directly exiting a supply line may reduce flowrate requirements of the liquid cooling system and the number or size of pumps required to meet the reduced flowrate requirements. Reducing pump size and number may result in lower power consumption for pumping, thus reducing overall cooling costs of the liquid cooling system.

Also stored in RAM (168) is an operating system (154). Operating systems useful for configuring a liquid cooling system according to embodiments of the present invention include UNIX™ Linux™ Microsoft XP™ Windows 7™ AIX™ IBM's i™, and others as will occur to those of skill in the art. The operating system (154) and the valve controller (199) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for configuring a liquid cooling system according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (183), which is an example of an I/O adapter specially designed for graphic output to a display device (180) such as a display screen or computer monitor. Video adapter (183) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100) and with a data center (192). Data communications with the data center (192) may include the valve controller (199) receiving input from sensors (not shown) of the liquid cooling system (197) and configuring one or more valves (not shown) within the liquid cooling system (197). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for configuring a liquid cooling system according to embodiments of the present invention include modems for wired dial-up communications, Ethernet (IEEE 802.3) adapters for wired data communications network communications, and 802.11 adapters for wireless data communications network communications.

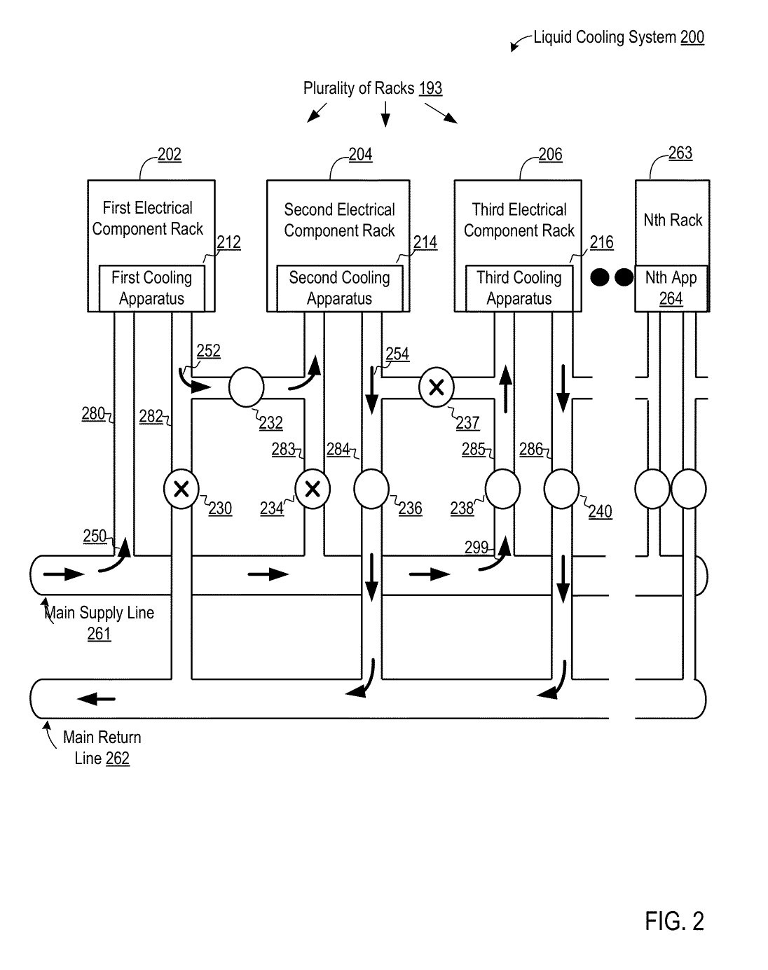

As explained above, according to embodiments of the present invention, a liquid cooling system may be configured by a valve controller controlling one or more valves within the liquid cooling system. For further explanation, FIG. 2 sets forth a block diagram of an example liquid cooling system (200) configured according to embodiments of the present invention. As explained above, a valve controller may be implemented in a variety of forms. For example, FIG. 1 illustrates an embodiment of a valve controller implemented with a computer. According to other embodiments of the present invention, a valve controller may be implemented using simple control circuitry or a temperature actuated valve. In the examples of FIGS. 2-5, the liquid cooling system may be configured by any type of valve controller, from a temperature actuated valve to a complex computer.

The liquid cooling system (200) of FIG. 2 includes ‘n’ number of cooling apparatuses configured to cool ‘n’ number of electrical component racks, where ‘n’ is some integer. The example of FIG. 2 illustrates a first cooling apparatus (212) configured to cool a first electrical component rack (202), a second cooling apparatus (214) configured to cool a second electrical component rack (204), a third cooling apparatus (216) configured to cool a third electrical component rack (206), and an ‘n’th cooling apparatus (264) configured to cool an ‘n’th electrical component rack (263). An electrical component rack is a collection of electrical components stored in some form of enclosure. A cooling apparatus is a type of liquid cooling component. Examples of individual cooling apparatuses include, but are not limited to, air-to-liquid heat exchangers, such as rear door heat exchangers and side-car type heat exchangers (sometimes referred to as in-row coolers), and direct liquid cooling systems. A rear door heat exchanger is an air-to-liquid heat exchanger which transfers heat from air (which was warmed as it flowed through the electrical component) to the liquid flowing through it. This rear door heat exchanger is located in a rear door of an electrical component rack. A side-car type heat exchanger is similar in concept to a rear door heat exchanger except the air leaving the rear of the rack is redirected across an air-to-water heat exchanger that is located adjacent to the rack on its side. A direct liquid cooling system involves direct contact between the components being cooled and the liquid medium. Examples of direct liquid cooling systems include pipes and coldplates containing liquid directly coupled to components within an electrical component rack, or direct liquid immersion cooling. Examples of the liquid used in the liquid cooling system may include but are not limited to water, ethylene glycol, dielectric fluids, and other liquids as would occur to one of skill in the art.

The liquid cooling system (200) of FIG. 2 also includes a main supply line (261) and a main return line (262). A supply line supplies liquid to a cooling apparatus which uses the liquid to remove heat from an electrical component rack. The heated liquid is eventually feed into a return line, which removes the liquid from the liquid cooling system (200). A liquid cooling system may use a variety of sources for supply line liquid. For example, a liquid cooling system may utilize an outdoor liquid reservoir which local climate keeps cool enough for use in the liquid cooling system. In warmer climates, the liquid supply may be cooled by a Chiller. To maintain movement of liquid through the main supply line (261) and the main return line (262), the liquid cooling system (200) may utilize one or more pumps, such as the pumps (191) of FIG. 1. Depending upon the source of the liquid, this pump may be very close or very far from the electrical racks

In the example of FIG. 2, each cooling apparatus is coupled to the main supply line (261) with an individual supply line and to the main return line (262) with an individual return line. For example, the first cooling apparatus (212) has a first individual supply line (280) and a first individual return line (282). The second cooling apparatus (214) has a second individual supply line (283) and a second individual return line (284). Likewise, the third cooling apparatus (216) has a third individual supply line (285) and a third individual return line (286).

As explained above, according to embodiments of the present invention, under particular conditions, a particular cooling apparatus may be configured to use the liquid directly exiting another cooling apparatus. Under other conditions, this particular cooling apparatus may be configured to not use the liquid directly exiting another cooling apparatus but instead to use liquid directly exiting the main supply line. To change between these configurations, one or more valves connected to the individual supply lines and the individual return lines may be opened or closed.

For example, a valve (230) coupling the individual return line (282) of the first cooling apparatus (212) to the main return line (262), controls whether liquid directly exiting the first cooling apparatus (212) is allowed to flow to the main return line (262). A valve (232) coupling the individual return line (282) of the first cooling apparatus (212) to the individual supply line (283) of the second cooling apparatus, controls whether liquid directly exiting the first cooling apparatus (212) is allowed to flow to the second individual supply line (283) and into the second cooling apparatus (214). In the example of FIG. 2, a valve (234) coupling the individual supply line (283) of the second cooling apparatus (214) to the main supply line (261), controls whether the second cooling apparatus (214) uses liquid directly exiting the main supply line (261). Valves (236, 237, 238, 240) also are likewise configured to control individual supply lines and individual return lines of the second cooling apparatus (214) and the third cooling apparatus (216).

In the example of FIG. 2, valves (230 and 234) are closed and the valve (232) is open such that liquid directly exiting the first cooling apparatus (212) is used in the second cooling apparatus (214). That is, liquid directly exiting the first cooling apparatus (212) is used in the second cooling apparatus (214) to cool the second electrical component rack (204). However, the third cooling apparatus (216) does not use the liquid directly exiting the second cooling apparatus (214) and instead uses liquid (299) directly exiting the main supply line (261).

In the example of FIG. 2, the second cooling apparatus (214) is in series with the first cooling apparatus (212) and the third cooling apparatus (216) is in parallel with the first cooling apparatus (212) and the second cooling apparatus (214). Readers of skill in the art will realize that any number of cooling apparatuses may be in placed in a series configuration with each other according to embodiments of the present invention and any number of cooling apparatuses may also be placed in a parallel configuration.

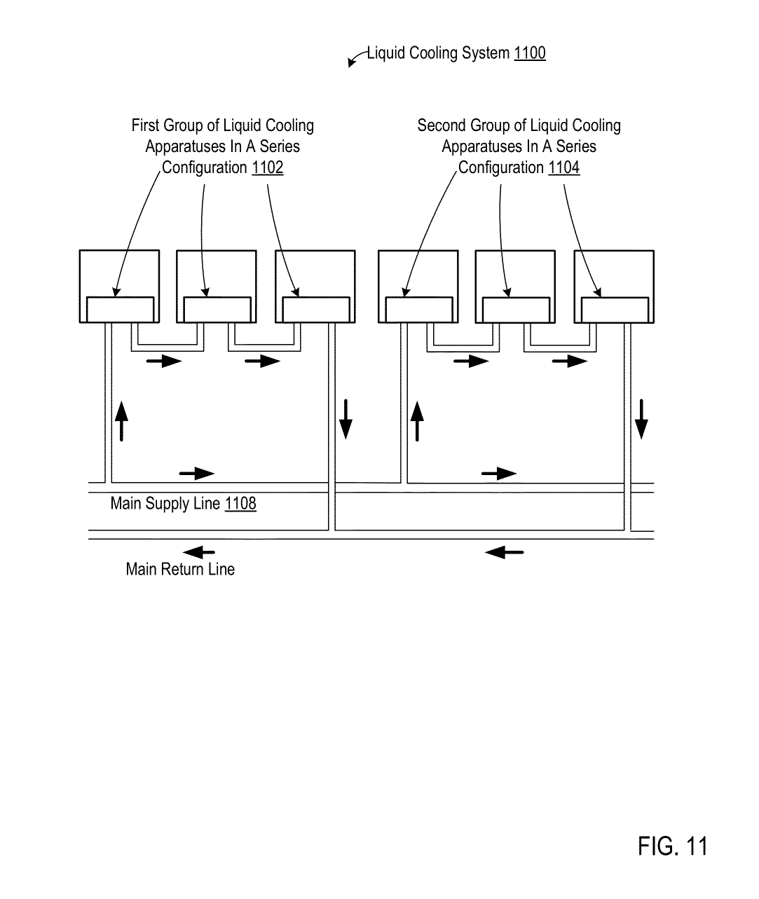

Furthermore, as will be explained in greater detail in the example of FIG. 11, any number of groups containing cooling apparatuses in a series configuration may be placed in parallel with each other. For example, a particular configuration may include a group of three cooling apparatuses each in series with each other and another group of four cooling apparatuses each in series with each other. In this example, the two groups may be in parallel with each other. Readers of skill in the art will realize that any number of cooling apparatuses may form a series configuration group and be in parallel with any number of other series configuration groups of cooling apparatuses, with each group containing any number of cooling apparatuses in series with each other.

Placing one or more cooling apparatuses in series enables a reduction in the overall flowrate required to be provided to main supply line (261) and therefore reduces pumping requirements. Reducing pumping requirements may result in smaller or fewer pumps required for the Data Center construction and hence reduce up front capital costs, as well as reduced pump power consumption and thus result in lower operating expenses for a data center.

In addition to the benefit of reducing pumping power consumption, if the flowrate requirements can be reduced at any time for a given heat load, then the resulting return temperature of the liquid is higher. In some circumstances it may be desirable to have a lower flowrate/higher liquid temperature return flow than it is for a higher flowrate/lower liquid temperature return flow, because it is more efficient from a chiller cooling perspective to have a higher temperature delta for re-cooling the liquid for ongoing usage in the liquid loop. That is, a series configuration may result in greater efficiency and cost savings over a parallel configuration and therefore using a valve controller to determine when to implement a series configuration may be desirable. It may also be desirable to have a higher return liquid temperature if the liquid is to be subsequently used for building heating.

Finally, data centers are implementing free liquid cooling, where the temperature of the free liquid available to the data center varies with the outside weather, where this variation has daily variations as well as seasonal variations. Since the infrastructure must provide sufficient cooling for the warmest liquid of the year, there is a significant portion of the year where the data center is over cooled. During these times of lower outside temperatures, methodologies described herein can be exploited to reduce the ongoing pumping (operating) costs.

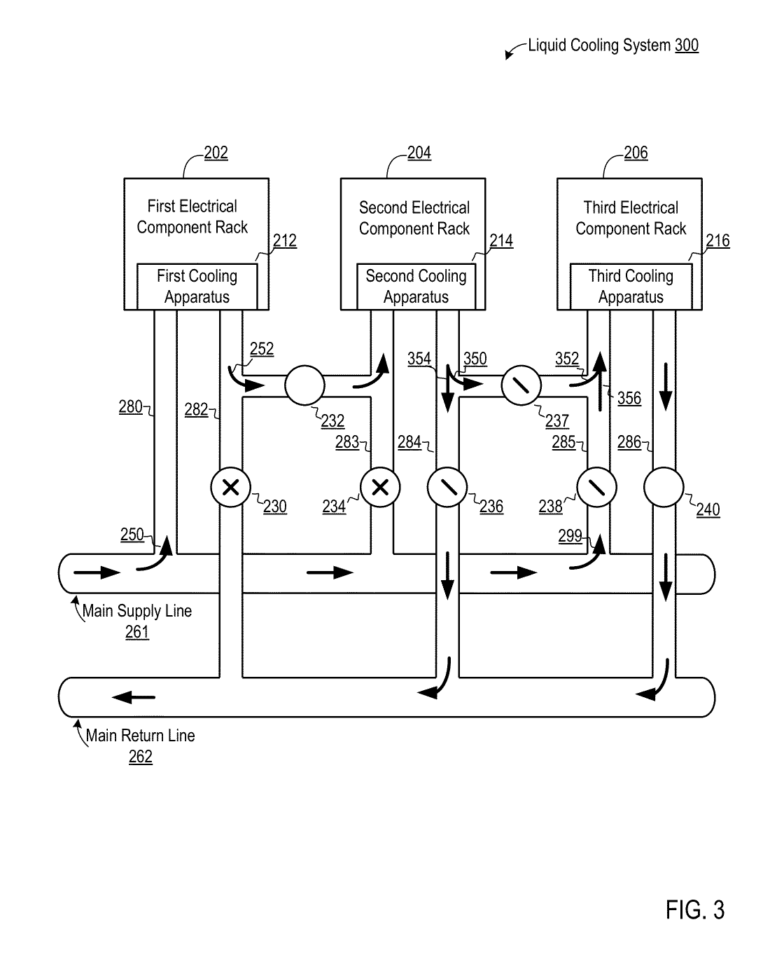

As explained above, according to embodiments of the present invention, a liquid cooling system may be configured by a valve controller controlling one or more valves within the liquid cooling system. For further explanation, FIG. 3 sets forth a block diagram of another example liquid cooling system (300) configured according to embodiments of the present invention.

The liquid cooling system of FIG. 3 is similar to the liquid cooling system of FIG. 2 in that the liquid cooling system of FIG. 3 also includes the following components of FIGS. 1 and 2: the first cooling apparatus (212), the second cooling apparatus (214), the third cooling apparatus (216), the main supply line (261), the main return line (262), the individual supply lines (280, 283, 285), the individual return lines (282, 284, 286), and the valves (230-240).

In the liquid cooling system of FIG. 3, however, some of the valves are partially open or closed as opposed to entirely open or closed as in FIG. 2. For example, the valve (237) coupling the individual return line (284) of the second cooling apparatus (214) and the individual supply line (285) of the third cooling apparatus (216) is partially open instead of closed. Also, in the liquid cooling system of FIG. 3, the valve (238) coupling the main supply line (261) to the individual supply line (285) of the third cooling apparatus is partially open instead of completely open. In addition, in the liquid cooling system of FIG. 3, the valve (236) coupling the main return line (262) to the individual return line (284) of the second cooling apparatus is partially open instead of completely open.

With the three valves (236, 237, 238) partially open, the liquid directly exiting the second cooling apparatus includes some liquid (354) flowing directly from the second cooling apparatus (214) into the main return line (262) and some liquid (350) flowing directly from the second cooling apparatus (214), through the valve (237), and into the individual supply line (285) of the third cooling apparatus (216). The third cooling apparatus is therefore cooled by liquid directly exiting the second cooling apparatus (214) as well as some liquid directly exiting the main supply line (261). The example of FIG. 3 illustrates a configuration that enables the third cooling apparatus (216) to have some of the benefits of a wholly series configuration without having to meet all of the requirements for implementing a series configuration.

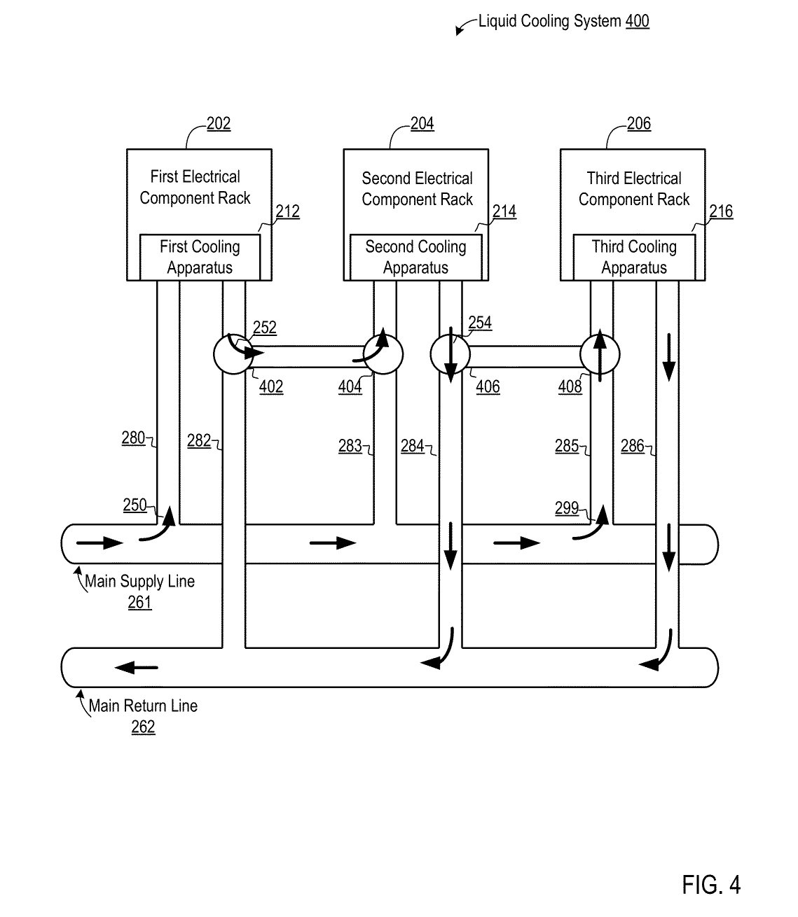

As explained above, according to embodiments of the present invention, a liquid cooling system may be configured by a valve controller controlling one or more valves within the liquid cooling system. For further explanation, FIG. 4 sets forth a block diagram of another example liquid cooling system (400) configured according to embodiments of the present invention.

The liquid cooling system of FIG. 4 is similar to the liquid cooling system of FIG. 2 in that the liquid cooling system of FIG. 4 also includes the following components of FIGS. 1 and 2: the first cooling apparatus (212), the second cooling apparatus (214), the third cooling apparatus (216), the main supply line (261), the main return line (262), and the individual supply lines (280, 283, 285), and the individual return lines (282, 284, 286).

In the liquid cooling system of FIG. 4, however, ‘three-way valves’ are used to couple the individual supply and return lines to each other and to the main supply line (261) and the main return line (262). A ‘three-way valve’ allows liquid to flow in one or more directions. For example, in FIG. 4, three way valves (402,404) couple the individual return line (282) of the first cooling apparatus (212) to both the main return line (262) and the individual supply line (283) of the second cooling apparatus (214). In the example of FIG. 4, three way valves (406, 408) also couple the individual return line (284) of the second cooling apparatus (214), the individual supply line (285) of the third cooling apparatus (216), the main supply line (261), and the main return line (262).

In the example configuration of FIG. 4, liquid (252) directly exiting the first cooling apparatus (212) flows through the three way valves (402, 404) and into the second cooling apparatus (214). That is, the first cooling apparatus (212) and the second cooling apparatus (214) are connected in series. The liquid (254) directly exiting the second cooling apparatus (214) flows through the three way valve (406) into the main return line (262) and the liquid (299) directly exiting the main supply line (261) flows through the valve (408) into the third cooling apparatus (216). That is, the third cooling apparatus (216) is in parallel with the first cooling apparatus (212) and the second cooling apparatus (214).

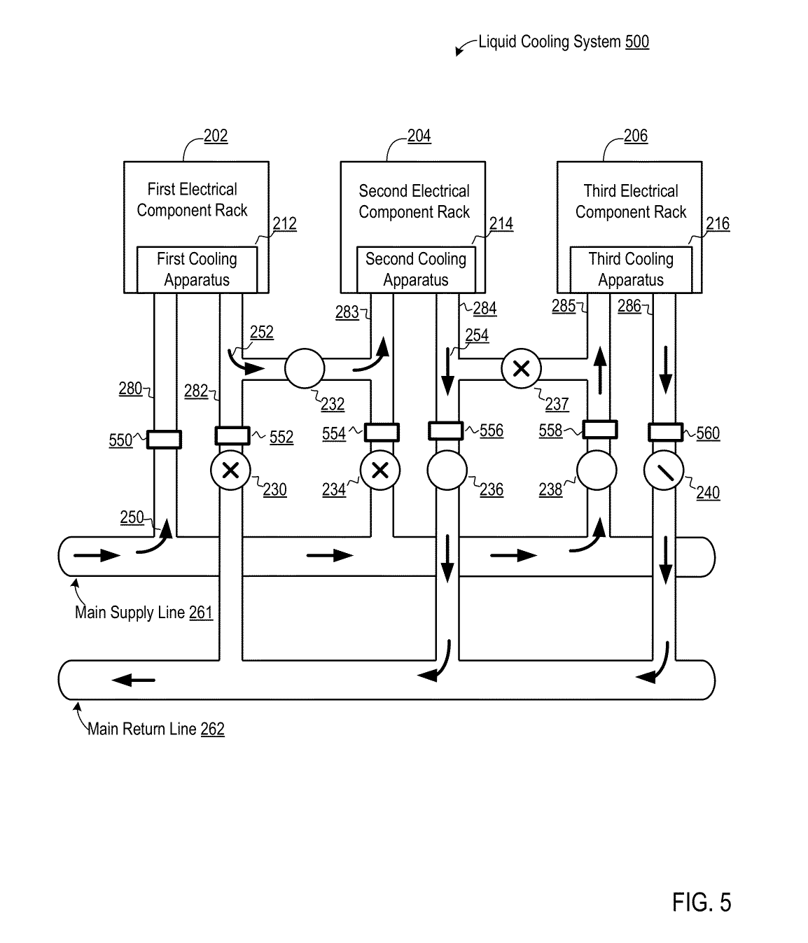

As explained above, according to embodiments of the present invention, a liquid cooling system may be configured by a valve controller controlling one or more valves in the liquid cooling system. For further explanation, FIG. 5 sets forth a block diagram of another example liquid cooling system (500) configured according to embodiments of the present invention.

The liquid cooling system of FIG. 5 is similar to the liquid cooling system of FIG. 2 in that the liquid cooling system of FIG. 5 also includes the following components of FIGS. 1 and 2: the first cooling apparatus (212), the second cooling apparatus (214), the third cooling apparatus (216), the main supply line (261), the main return line (262), and the individual supply lines (280, 283, 285), the individual return lines (282, 284, 286), and the valves (230-240).

In the liquid cooling system of FIG. 5, however, the individual supply lines (280, 283, 285) and the individual return lines (282, 284, 286) are coupled to the main supply line (261) and the main return line (262), respectively, with quick connect fittings (550-560). A quick connect fitting is used to provide a quick hose connection between the main supply line (261) and the individual supply lines, and also between the individual return lines and the main return line (262). A quick connect fitting may result in high pressure drop, but is typically desired for the convenience of interconnecting and disconnecting the individual cooling apparatus' to/from the main supply and return lines. In many cases, the pressure drop across the quick connect fittings are large compared to the pressure drop across the cooling apparatus.

The concepts described above allow many racks to be cooled in a series configuration allowing the same liquid to be used for rack after rack. For instance, if ten racks were able to be run in a series configuration then the flowrate requirement would be decreased to one-tenth of the original value. However, if pressure drop increases by a multiple of ten then there may be no savings on pumping power. Similarly, it may be undesirable if there is a significant decrease in flowrate to the longer paths as compared to the shorter paths.

For example in FIG. 5, the pressure drop for the first two cooling apparatuses consists of that from two pairs of quick connects and two cooling apparatuses, while the pressure drop for the third apparatus consists of that from two pairs of quick connects and one cooling apparatus. Since the pressure drop of the quick connects is much larger than that of the cooling apparatus, the pressure drop for two apparatus in series is not much larger than for one apparatus by itself. Hence, we have decreased the flowrate requirement for the first two apparatuses by fifty percent, while having a very small increase in pressure drop. Hence, we have made a dramatic reduction in total pumping power. This effect is further diminished since there is often a significant pressure drop between the pumps and the main supply and return lines. This effect may also be unaffected by how many racks are in series. This pressure drop results from the distance the liquid must be pumped to reach the cooling apparatus, filters and valves. Hence the true percent increase in pressure drop due to multiple apparatus in series may be even smaller than expected. This concept adds to the flow uniformity between the different paths. Since the pressure drop through the first two apparatuses is nearly the same as through the third, it will receive nearly the same liquid flowrate. Finally, an installation could deploy repeating groups of N racks in series. In this case the flow may be automatically balanced irrespective of the pressure drop caused by the quick connects.

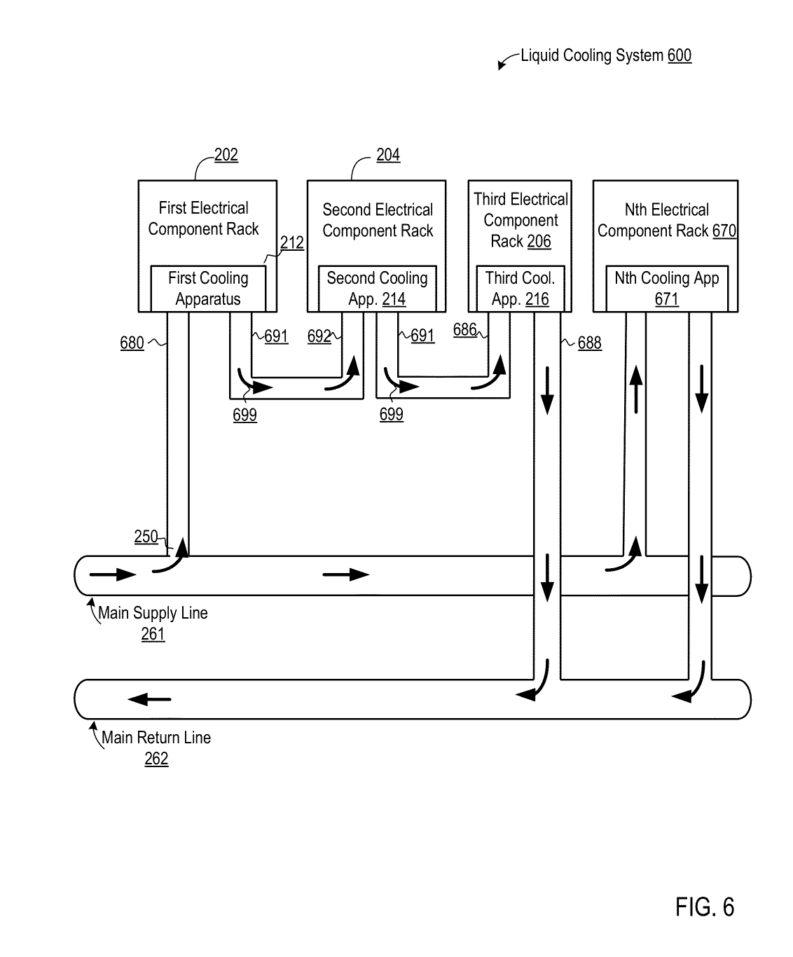

As explained above, according to embodiments of the present invention, a liquid cooling system may also be configured without the use of a valve controller and valves. That is, according to embodiments of the present invention, a liquid cooling system may be ‘hard-plumped’ to a particular configuration. For example, if one or more conditions of a liquid cooling system are known, such as supply liquid temperature, rack power consumption, flowrate, etc., the configuration of the system may be hard-plumped. For instance, this could be as simple as having 6 racks in series for 9 months of the year when the liquid temperature is below 30 C, and reduce to 5 racks in series when the liquid temperature is greater than 30 C. For further explanation, FIG. 6 sets forth a block diagram of another example liquid cooling system (600) configured according to embodiments of the present invention.

The liquid cooling system of FIG. 6 is similar to the liquid cooling system of FIG. 2 in that the liquid cooling system of FIG. 6 also includes the following components of FIGS. 1 and 2: the first cooling apparatus (212), the second cooling apparatus (214), the third cooling apparatus (216), the Nth cooling apparatus (264), the main supply line (261), and the main return line (262).

In the liquid cooling system of FIG. 6, however, the individual supply lines and individual return lines are directly coupled to one of the main supply line (261), the main return line (262), or to another individual supply line or individual return line without using valves. For example, in FIG. 6, an individual return line (691) of the first cooling apparatus (212) is directly coupled to an individual supply line (692) of the second cooling apparatus (214) and the individual supply line (686) of the third cooling apparatus (216) is directly coupled to the individual return line (691) of the second cooling apparatus (214). In the configuration of FIG. 6, liquid (699) directly exiting the first cooling apparatus (212) is used in the second cooling apparatus (214) and liquid directly exiting the second cooling apparatus (214) is used in the third cooling apparatus (216). A Nth cooling apparatus (264) is illustrated as directly connected to the main supply line (261) and the main return line (262). That is, the first cooling apparatus (212), the second cooling apparatus (214), and the third cooling apparatus (216) are each in series with each other. Although only three cooling apparatuses are illustrated in series with each other, readers of skill in the art will realize that any number of cooling apparatus may be placed in series with each other. The Nth cooling apparatus (264) is in parallel with the series combination of the first cooling apparatus (212), the second cooling apparatus (214), and the third cooling apparatus (216).

As explained above, a configuration of a liquid cooling system may be changed in response to changing conditions or goals for the liquid cooling system. To change the configuration of a liquid cooling system, one or more valve controllers may be used. A valve controller is automated machinery configured to control conditions such as direction, flow, pressure, temperature, and liquid level in the liquid cooling system by fully or partially opening or closing one or more valves.

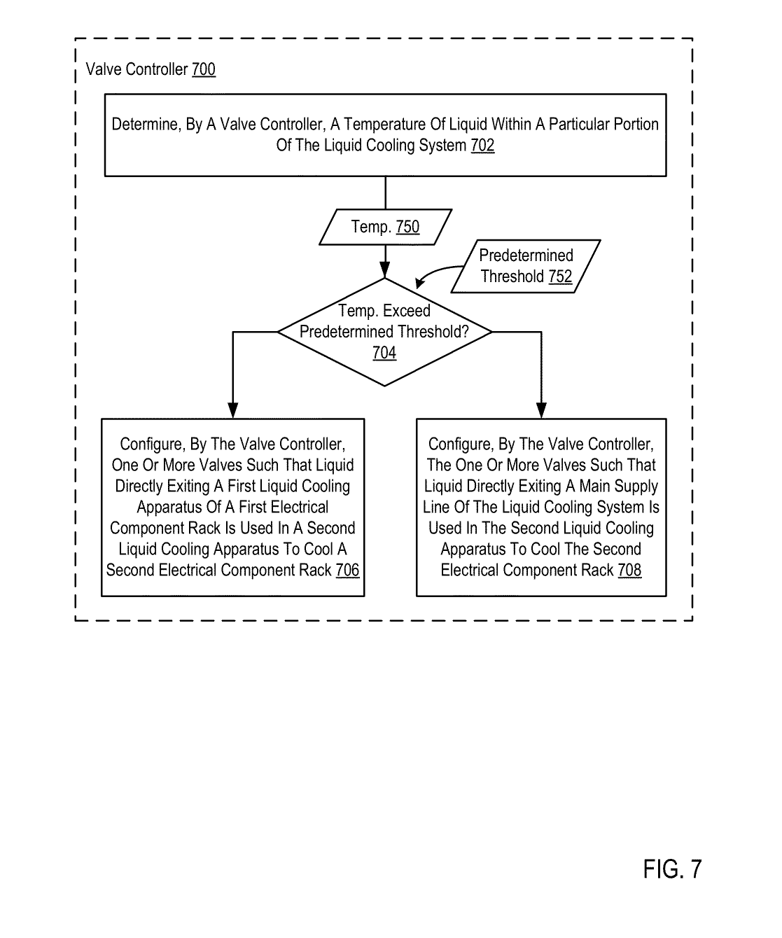

In a particular embodiment of the present invention, a valve controller may be integrated into a particular valve and be configured to control only that valve. In other embodiments, a valve controller may be configured to control a plurality of valves and may be located anywhere outside the valve, such as a control room of a data center. Readers of skill in the art will realize that a valve controller may have many forms and capabilities according to embodiments of the present invention. For further explanation, FIG. 7 sets forth a flow chart illustrating an exemplary method for configuring a liquid cooling system according to embodiments of the present invention. For ease of explanation, the example liquid cooling systems of FIGS. 2-5 are referenced in explaining the method of FIG. 7.

The method of FIG. 7 includes determining (702), by a valve controller (700), a temperature (750) of liquid within a particular portion of the liquid cooling system (200). A particular portion of the liquid cooling system may be any location within the liquid cooling system. That is, a valve controller may change a configuration of a liquid cooling system based on some temperature information associated with some portion of the liquid cooling system. For example, a liquid cooling system may use liquid from a pond outside a data center to cool electrical components within the data center. In this example, a temperature of the liquid from the pond may be predicable or easily obtainable and entered by a user. In other embodiments, a valve controller may monitor the temperature of liquid at some location within the liquid cooling system. For example, a liquid cooling system may include one or more temperature sensors. According to embodiments of the present invention, these temperature sensors may be located within a valve or be a stand-alone sensor. Also, the temperature sensors may be directly connected to a valve controller or may transmit temperature information though a data communications network to a valve controller. Determining (702), by a valve controller (700), a temperature (750) of liquid within a particular portion of the liquid cooling system (200) may be carried out by receiving user input that indicates a liquid temperature or receiving temperature information from one or more temperature sensors.

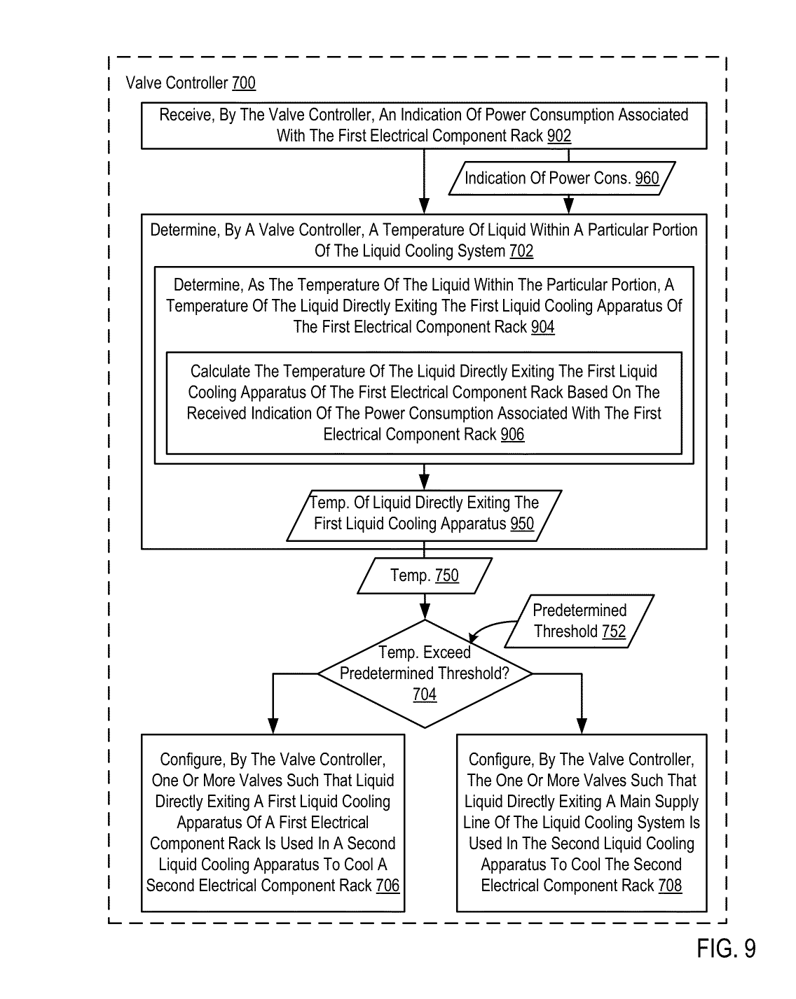

In addition, as will be discussed in FIG. 9, a valve controller may also determine (702) the temperature of liquid within a particular portion of the liquid cooling system based on other non-liquid temperature data, such as power consumption of electrical components and a known volumetric liquid flowrate, temperature of electrical components, or air temperature inside or outside of a data center. For example, a valve controller may ‘determine’ that a temperature of the liquid directly exiting a supply line is thirty-four degrees Celsius when the supply temperature of the liquid to the cooling apparatus is 30 C, and 10 KW of heat was removed by a 10 gpm liquid flowrate.

The method of FIG. 7 also includes determining (704), by the valve controller (700), whether the temperature (750) of the liquid within the particular portion of the liquid cooling system exceeds a predetermined threshold (752). A predetermined threshold may be user configurable and be selected based on the heat removal requirements of the cooling apparatuses. For example, if a cooling apparatus needs liquid at a particular flowrate at a particular temperature, then the predetermined threshold (752) may be set to the particular temperature. Determining (704), by the valve controller (700), whether the temperature (750) of the liquid within the particular portion of the liquid cooling system exceeds a predetermined threshold (752) may be carried out by retrieving the temperature (750) of the liquid; retrieving the predetermined threshold (752); and comparing the temperature (750) of the liquid to the predetermined threshold (752).

If the temperature (750) of the liquid within the particular portion of the liquid cooling system (200) does not exceed the predetermined threshold (752), the method of FIG. 7 continues by configuring (706), by the valve controller (199), one or more valves (230, 232, 234) such that liquid (252) directly exiting a first liquid cooling apparatus (212) of a first electrical component rack (202) is used in a second liquid cooling apparatus (214) to cool a second electrical component rack (204). Configuring (706), by the valve controller (199), one or more valves (232, 234) such that liquid (252) directly exiting a first liquid cooling apparatus (212) of a first electrical component rack (202) is used in a second liquid cooling apparatus (214) to cool a second electrical component rack (204) may be carried out by at least partially closing the valve (230) coupling the individual return line (282) of the first cooling apparatus to the main return line (262); at least partially opening the valve (232) coupling the individual return line (282) of the first cooling apparatus to the individual supply line (283) of the second cooling apparatus (214); and at least partially closing the valve (234) coupling the individual supply line (234) of the second cooling apparatus to the main supply line (261). That is, the second cooling apparatus (214) uses liquid directly exiting the first cooling apparatus (212) to cool the second electrical component rack (204).

If the temperature (750) of the liquid within the particular portion of the liquid cooling system (200) exceeds the predetermined threshold (752), the method of FIG. 7 continues by configuring (708), by the valve controller (199), the one or more valves (236, 237, 238) such that liquid (299) directly exiting a main supply line (261) of the liquid cooling system (200) is used in the third liquid cooling apparatus (216) to cool the third electrical component rack (206). Configuring (708), by the valve controller (199), the one or more valves (236, 237, 238) such that the liquid (299) directly exiting the main supply line (261) of the liquid cooling system (200) is used in the third liquid cooling apparatus (216) to cool the third electrical component rack (206) may be carried out by at least partially closing the valve (237) coupling the individual return line (284) of the second cooling apparatus (214) to the individual supply line (285) of the third cooling apparatus (216); at least partially opening the valve (236) coupling the individual return line (284) to the main return line (262); and at least partially opening the valve (238) coupling the individual supply line (285) of the third cooling apparatus (216) to the main supply line (261). That is, the third cooling apparatus (216) uses liquid directly exiting the main supply line (261) to cool the third electrical component rack (206). Readers of skill in the art will realize that ‘at least partially opening’ a valve may include completely opening the valve and likewise, ‘at least partially closing’ a valve may include completely closing the valve. That is, in a particular embodiment, the second electrical component rack (204) is entirely cooled by the liquid (252) directly exiting the first cooling apparatus (212) and the third electrical component rack (206) is entirely cooled by the liquid (299) directly exiting the main supply line (261).

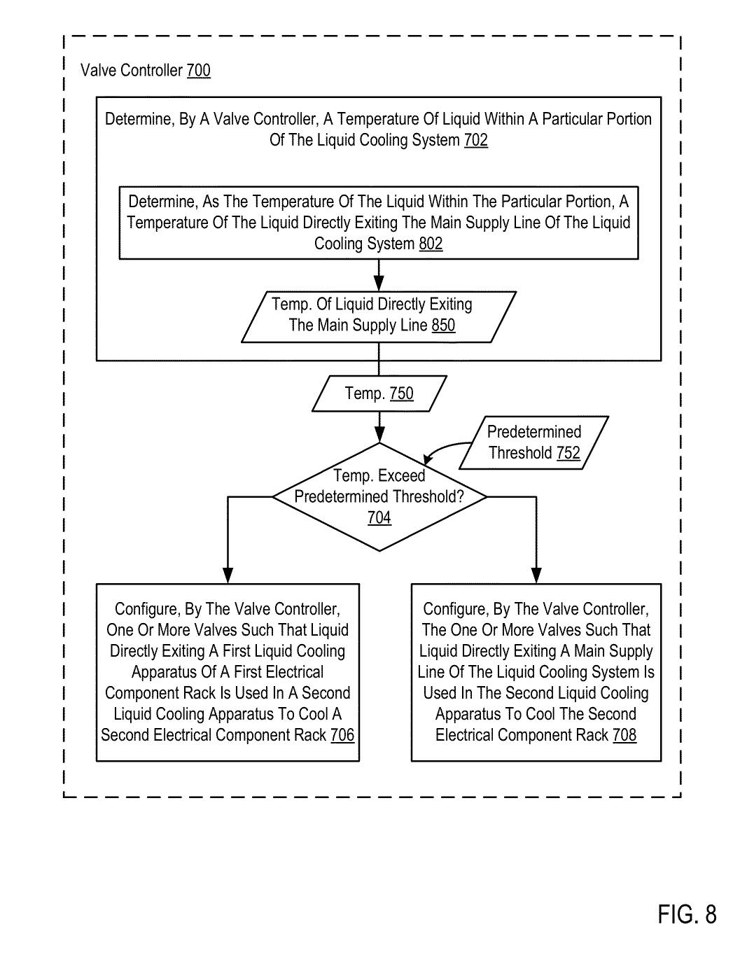

For further explanation, FIG. 8 sets forth a flow chart illustrating a further exemplary method for configuring a liquid cooling system according to embodiments of the present invention. For ease of explanation, the example liquid cooling systems of FIGS. 2-5 are referenced in explaining the method of FIG. 8.

The method of FIG. 8 is similar to the method of FIG. 7 in that the method of FIG. 8 also includes determining (702) a temperature (750) of liquid within a particular portion of the liquid cooling system (200); determining (704) whether the temperature (750) of the liquid within the particular portion of the liquid cooling system exceeds a predetermined threshold (752); if the predetermined threshold (752) is not exceeded, configuring (706) one or more valves (232, 234) such that liquid (252) directly exiting a first liquid cooling apparatus (212) of a first electrical component rack (202) is used in a second liquid cooling apparatus (214) to cool a second electrical component rack (204); and if the predetermined threshold (752) is exceeded, configuring (708) the one or more valves (232, 234) such that liquid (250) directly exiting a main supply line (261) of the liquid cooling system (200) is used in the second liquid cooling apparatus (214) to cool the second electrical component rack (204).

In the method of FIG. 8, however, determining (702) a temperature (750) of liquid within a particular portion of the liquid cooling system (200) includes determining (802), as the temperature (750) of the liquid within the particular portion, a temperature (850) of the liquid (250) directly exiting the main supply line (261) of the liquid cooling system (200). As explained above, a valve controller may ‘determine’ a temperature a variety of different ways including from temperature sensors, non-temperature sensors, and directly from a user. Determining (802), as the temperature (750) of the liquid within the particular portion, a temperature (850) of the liquid (250) directly exiting the main supply line (261) of the liquid cooling system (200) may be carried out by receiving user input that indicates a liquid temperature, receiving temperature information from one or more temperature sensors, and receiving non-temperature information concerning one or more components of the liquid cooling system or electrical components being cooled.

For further explanation, FIG. 9 sets forth a flow chart illustrating a further exemplary method for configuring a liquid cooling system according to embodiments of the present invention. For ease of explanation, the example liquid cooling systems of FIGS. 2-5 are referenced in explaining the method of FIG. 9.

The method of FIG. 9 is similar to the method of FIG. 7 in that the method of FIG. 9 also includes determining (702) a temperature (750) of liquid within a particular portion of the liquid cooling system (200); determining (704) whether the temperature (750) of the liquid within the particular portion of the liquid cooling system exceeds a predetermined threshold (752); if the predetermined threshold (752) is not exceeded, configuring (706) one or more valves (232, 234) such that liquid (252) directly exiting a first liquid cooling apparatus (212) of a first electrical component rack (202) is used in a second liquid cooling apparatus (214) to cool a second electrical component rack (204); and if the predetermined threshold (752) is exceeded, configuring (708) the one or more valves (232, 234) such that liquid (250) directly exiting a main supply line (261) of the liquid cooling system (200) is used in the second liquid cooling apparatus (214) to cool the second electrical component rack (204).

The method of FIG. 9 includes receiving (902), by the valve controller (700), an indication (960) of power consumption associated with the first electrical component rack (202). An indication of power consumption is a measurement or reference to an amount of power that one or more electrical components are consuming. Indications of power consumption that a particular electrical component is consuming may be measured by the particular electrical component or by another device, such as a power distribution unit (PDU) providing the power to the particular electrical component. In addition, a user may also input an indication of power consumption to the valve controller. Receiving (902), by the valve controller (700), an indication (960) of power consumption associated with the first electrical component rack (202) may be carried out by receiving an indication from an electrical component or from a power distribution unit and receiving user input indicating power consumption.

In the method of FIG. 9, however, determining (702) a temperature (750) of liquid within a particular portion of the liquid cooling system (200) includes determining (904), as the temperature (750) of the liquid within the particular portion, a temperature (950) of the liquid (252) directly exiting the first liquid cooling apparatus (212) of the first electrical component rack (202). Determining (904), as the temperature (750) of the liquid within the particular portion, a temperature (950) of the liquid (252) directly exiting the first liquid cooling apparatus (212) of the first electrical component rack (202) may be carried out by receiving user input that indicates a liquid temperature, receiving temperature information from one or more temperature sensors, receiving non-temperature information concerning one or more components of the liquid cooling system or electrical components being cooled, and flowrate within one or more cooling apparatuses. That is, a valve controller may configure one or more valves based on some combination of information indicating supply line temperature, power consumption of electrical components, and flowrate.

In the method of FIG. 9, determining (904), as the temperature (750) of the liquid within the particular portion, a temperature (950) of the liquid (252) directly exiting the first liquid cooling apparatus (212) of the first electrical component rack (202) may also include calculating (906) the temperature (950) of the liquid directly exiting the first liquid cooling apparatus (212) of the first electrical component rack (202) based on the received indication (960) of the power consumption associated with the first electrical component rack (202). Calculating (906) the temperature (950) of the liquid directly exiting the first liquid cooling apparatus (212) of the first electrical component rack (202) based on the received indication (960) of the power consumption associated with the first electrical component rack (202) may be carried out by using a set of power-temperature conversion rules to calculate the temperature (950) based on the indication (960). Power-temperature conversion rules may indicate the temperature of liquid at some portion of the liquid cooling system when a particular component is consuming a particular amount of power. For example, a valve controller may calculate that a rack consuming a particular amount of power results in a particular temperature of liquid directly exiting a cooling apparatus configured to cool the server.

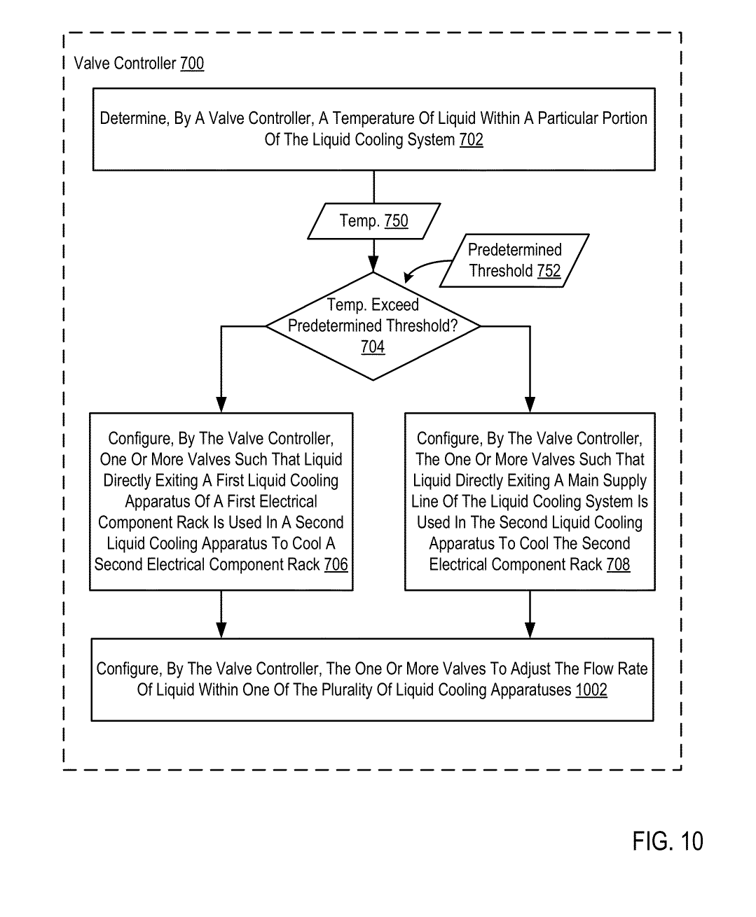

For further explanation, FIG. 10 sets forth a flow chart illustrating a further exemplary method for configuring a liquid cooling system according to embodiments of the present invention. For ease of explanation, the example liquid cooling systems of FIGS. 2-5 are referenced in explaining the method of FIG. 10.

The method of FIG. 10 is similar to the method of FIG. 7 in that the method of FIG. 10 also includes determining (702) a temperature (750) of liquid within a particular portion of the liquid cooling system (200); determining (704) whether the temperature (750) of the liquid within the particular portion of the liquid cooling system exceeds a predetermined threshold (752); if the predetermined threshold (752) is not exceeded, configuring (706) one or more valves (232, 234) such that liquid (252) directly exiting a first liquid cooling apparatus (212) of a first electrical component rack (202) is used in a second liquid cooling apparatus (214) to cool a second electrical component rack (204); and if the predetermined threshold (752) is exceeded, configuring (708) the one or more valves (232, 234) such that liquid (250) directly exiting a main supply line (261) of the liquid cooling system (200) is used in the second liquid cooling apparatus (214) to cool the second electrical component rack (204).

The method of FIG. 10 also includes configuring (1002), by the valve controller (700), the one or more valves (240) to adjust the flow rate of liquid within one of the liquid cooling apparatuses. Configuring (1002), by the valve controller (700), the one or more valves (240) to adjust the flow rate of liquid within one of the liquid cooling apparatuses may be carried out by adjusting the liquid level or pressure within one or more valves.

As explained above, according to embodiments of the present invention, a liquid cooling system may be configured by a valve controller controlling one or more valves within the liquid cooling system. For further explanation, FIG. 11 sets forth a block diagram of another example liquid cooling system (1100) configured according to embodiments of the present invention.

In the example of FIG. 11, the liquid cooling system (1100) includes a first group (1102) of cooling apparatuses in a series configuration and a second group (1104) of cooling apparatuses in the series configuration. In this example, the two groups are in a parallel configuration with each other relative to the main supply line (1108). Readers of skill in the art will realize that any number of cooling apparatuses may form a group and any number of groups may be in parallel with each other relative to the main supply line. According to embodiments of the present invention, a valve controller may configure one or more valves such that a liquid cooling system includes the first group (1102) comprising cooling apparatuses in a series configuration and the second group (1004) comprising cooling apparatuses in the series configuration and where the first group (1102) and the second group (1004) are in parallel with each other. A valve controller may also be configured to change the number of cooling apparatuses in each group in response to changing conditions within the liquid cooling system (1100), such as change in liquid temperature, flowrate, power consumption, passage of time, or other conditions that may be measured, observed, and affect the cooling capabilities of the liquid cooling system.

Exemplary embodiments of the present invention are described largely in the context of a fully functional computer system for configuring a liquid cooling system. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-7. (canceled)

8. An apparatus for configuring a liquid cooling system, the liquid cooling system comprising of a plurality of liquid cooling apparatuses, each liquid cooling apparatus configured to cool a particular electrical component rack, the apparatus comprising a computer processor and a computer memory operatively coupled to the computer processor, the computer memory having disposed within it computer program instructions that, when executed by the computer processor, cause the apparatus to carry out the steps of:
determining, by a valve controller, a temperature of liquid within a particular portion of the liquid cooling system;
determining, by the valve controller, whether the temperature of the liquid within the particular portion of the liquid cooling system exceeds a predetermined threshold;
if the temperature of the liquid within the particular portion of the liquid cooling system does not exceed the predetermined threshold, configuring, by the valve controller, one or more valves such that liquid directly exiting a first liquid cooling apparatus of a first electrical component rack is used in a second liquid cooling apparatus to cool a second electrical component rack; and
if the temperature of the liquid within the particular portion of the liquid cooling system exceeds a predetermined threshold, configuring, by the valve controller, the one or more valves such that liquid directly exiting a main supply line of the liquid cooling system is used in the second liquid cooling apparatus to cool the second electrical component rack.

9. The apparatus of claim 8 wherein determining the temperature of the liquid within the particular portion of the liquid cooling system includes determining, as the temperature of the liquid within the particular portion, a temperature of the liquid directly exiting the main supply line of the liquid cooling system.

10. The apparatus of claim 8 wherein determining the temperature of the liquid within the particular portion of the liquid cooling system includes determining, as the temperature of the liquid within the particular portion, a temperature of the liquid directly exiting the first liquid cooling apparatus of the first electrical component rack.

11. The apparatus of claim 10 further comprising computer program instructions that, when executed by the computer processor, cause the apparatus to carry out the steps of:
receiving, by the valve controller, an indication of power consumption associated with the first electrical component rack; and
wherein determining, as the temperature of the liquid within the particular portion, the temperature of the liquid directly exiting the first liquid cooling apparatus of the first electrical component rack includes calculating the temperature of the liquid directly exiting the first liquid cooling apparatus of the first electrical component rack based on the received indication of the power consumption associated with the first electrical component rack.

12. The apparatus of claim 8 further comprising computer program instructions that, when executed by the computer processor, cause the apparatus to carry out the steps of configuring, by the valve controller, the one or more valves to adjust the flow rate of liquid within one of the liquid cooling apparatuses.

13. The apparatus of claim 8 wherein one of the first liquid cooling apparatus and the second liquid cooling apparatus is an air-to-liquid heat exchanger and wherein one of the first liquid cooling apparatus and the second liquid cooling apparatus is a direct liquid cooling system.

14. A computer program product for configuring a liquid cooling system, the liquid cooling system comprising of a plurality of liquid cooling apparatuses, each liquid cooling apparatus configured to cool a particular electrical component rack, the computer program product disposed upon a computer readable medium, the computer program product comprising computer program instructions that, when executed, cause a computer to carry out the steps of:
determining, by a valve controller, a temperature of liquid within a particular portion of the liquid cooling system;
determining, by the valve controller, whether the temperature of the liquid within the particular portion of the liquid cooling system exceeds a predetermined threshold;
if the temperature of the liquid within the particular portion of the liquid cooling system does not exceed the predetermined threshold, configuring, by the valve controller, one or more valves such that liquid directly exiting a first liquid cooling apparatus of a first electrical component rack is used in a second liquid cooling apparatus to cool a second electrical component rack; and
if the temperature of the liquid within the particular portion of the liquid cooling system exceeds a predetermined threshold, configuring, by the valve controller, the one or more valves such that liquid directly exiting a main supply line of the liquid cooling system is used in the second liquid cooling apparatus to cool the second electrical component rack.

15. The computer program product of claim 14 wherein determining the temperature of the liquid within the particular portion of the liquid cooling system includes determining, as the temperature of the liquid within the particular portion, a temperature of the liquid directly exiting the main supply line of the liquid cooling system.

16. The computer program product of claim 14 wherein determining the temperature of the liquid within the particular portion of the liquid cooling system includes determining, as the temperature of the liquid within the particular portion, a temperature of the liquid directly exiting the first liquid cooling apparatus of the first electrical component rack.

17. The computer program product of claim 16 further comprising computer program instructions that, when executed, cause a computer to carry out the steps of:
receiving, by the valve controller, an indication of power consumption associated with the first electrical component rack; and
wherein determining, as the temperature of the liquid within the particular portion, the temperature of the liquid directly exiting the first liquid cooling apparatus of the first electrical component rack includes calculating the temperature of the liquid directly exiting the first liquid cooling apparatus of the first electrical component rack based on the received indication of the power consumption associated with the first electrical component rack.

18. The computer program product of claim 14 further comprising computer program instructions that, when executed, cause a computer to carry out the steps of configuring, by the valve controller, the one or more valves to adjust the flow rate of liquid within one of the liquid cooling apparatuses.

19. The computer program product of claim 14 wherein one of the first liquid cooling apparatus and the second liquid cooling apparatus is an air-to-liquid rear door heat exchanger and wherein one of the first liquid cooling apparatus and the second liquid cooling apparatus is a direct liquid cooling system.

20. The computer program product of claim 14 wherein the computer readable medium comprises a signal medium.

21. The computer program product of claim 14 wherein the computer readable medium comprises a storage medium.

22. A liquid cooling system for cooling a plurality of electrical component racks, the liquid cooling system comprising:
a first liquid cooling apparatus configured to cool a first electrical component rack;
a second liquid cooling apparatus configured to cool a second electrical component rack; and
wherein the first liquid cooling apparatus and the second liquid cooling apparatus are connected such that liquid directly exiting the first liquid cooling apparatus of the first electrical component rack is used in the second liquid cooling apparatus to cool the second electrical component rack.

23. The liquid cooling system of claim 22 further comprising a third water cooling apparatus configured to cool a third electrical component rack,
wherein the third liquid cooling apparatus is coupled to a main supply line such that liquid directly exiting the main supply line is used in the third liquid cooling apparatus to cool the third electrical component rack.

24. The liquid cooling system of claim 23, wherein one of the first liquid cooling apparatus, the second liquid cooling apparatus, and the third liquid cooling apparatus is an air-to-liquid heat exchanger; and wherein one of the first liquid cooling apparatus, the second liquid cooling apparatus, and the third liquid cooling apparatus is a direct liquid cooling system.
